(19) United States
(12) Patent Application Publication
(10) Pub. No.: US 2008/0304097 A1
(43) Pub. Date: Dec. 11, 2008

(54) SYSTEM AND METHOD FOR STAGED PROCESSING OF ELECTRONIC DOCUMENT PROCESSING JOBS

(76) Inventors: Jose Elwin Simon MAGLANQUE, Regents Park (AU); Christopher Mark Bishop, Waiatarua (NZ); Lilian Ji, Ultimo (AU)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/760,297

(22) Filed: Jun. 8, 2007

(51) Int. Cl. G06F 3/12; G06F 17/00

(52) U.S. Cl. 358/1.15

(57) ABSTRACT

The subject application is directed to a system and method for staged processing of electronic document processing jobs. A plurality of electronic documents, inclusive of setting data representing document processing device operations, are first directed to at least one associated document processing device are received. Processing stages for each received electronic document are then identified based upon the corresponding setting data. Each received electronic document is thereafter communicated to the corresponding identified processing stages. A preselected document processing operation is then sequentially completed via each of the processing stages corresponding to each received electronic document.

### BACKGROUND OF THE INVENTION

The subject application is directed generally to processing of electronic documents for document output devices. The subject teachings are more generally applicable to efficient processing of electronic documents in a staged or pipelined process.

There are many electronic document formats in existence, with more being added or modified. Such electronic document formats include page description languages (PDLs), and typically require dedicated processing software or hardware to render them properly. Rendering operations include generation of bitmapped images through output devices, such as dot matrix printers, including laser printers, ink jet printers, facsimile machines, or the like. Rendering devices include limited palette devices, such as black-and-white output devices or gray-scale output devices, as well as color devices. Output media include paper, transparencies, and the like.

The number of different formats, and desired output attributes associated with electronic documents, makes it difficult, expensive, and time consuming to write appropriate software or assemble appropriate hardware to address the constantly evolving printing needs.

### SUMMARY OF THE INVENTION

In accordance with one embodiment of the subject application, there is provided a system and method for processing of electronic documents for document output devices.

Further, in accordance with one embodiment of the subject application, there is provided a system and method for efficient processing of electronic documents in a staged or pipelined process.

Still further, in accordance with one embodiment of the subject application, there is provided a system for staged processing of electronic document processing jobs. The system is comprised of means adapted for receiving a plurality of electronic documents directed to at least one associated document processing device, each received electronic document having setting data representative of document processing device operations corresponding thereto. The system is also comprised of identification means adapted for identifying a plurality of processing stages for each received electronic document in accordance with the setting data that corresponds thereto. The system further includes means adapted for communicating each received electronic document to a plurality of processing stages in accordance with an output of the identification means and means adapted for sequentially completing a preselected document processing operation via each of the plurality of processing stages corresponding to each received electronic document.

In one embodiment of the subject application, the system further comprises means adapted for ordering document processing operations for each electronic document in accordance with setting data corresponding thereto.

In another embodiment of the subject application, each processing stage is comprised of a filter, which filter includes means adapted for performing its corresponding preselected document processing operation in accordance with a portion of data associated with an electronic document. Preferably, the system further comprises means adapted for sequencing a plurality of the filters as groups of sub-filters, each sub-filter group performing a document processing operation related to other document processing operations in a corresponding group.

In yet another embodiment of the subject application, the setting data includes at least one of page markup data and print ticket data.

In a further embodiment of the subject application, the system further comprises means adapted for determining an encoding type associated with each electronic document and means adapted for selecting an identification means in accordance with a determined encoding type.

Still further, in accordance with one embodiment of the subject application, there is provided a method for staged processing of electronic document processing jobs in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for staged processing of electronic document processing jobs according to one embodiment of the subject application;

FIG. 2 is a block diagram illustrating controller hardware for use in the system for staged processing of electronic document processing jobs according to one embodiment of the subject application;

FIG. 3 is a functional diagram illustrating the controller for use in the system for staged processing of electronic document processing jobs according to one embodiment of the subject application;

FIG. 4 is a block diagram illustrating a workstation for use in the system for staged processing of electronic document processing jobs according to one embodiment of the subject application;

FIG. 5 is a block diagram illustrating a filter system for use in the system for staged processing of electronic document processing jobs according to one embodiment of the subject application;

FIG. 6 is a flowchart illustrating a method for staged processing of electronic document processing jobs according to one embodiment of the subject application; and

FIG. 7 is a flowchart illustrating a method for staged processing of electronic document processing jobs according to one embodiment of the subject application.

### DETAILED DESCRIPTION OF THE PREFERRED EMBODIMENT

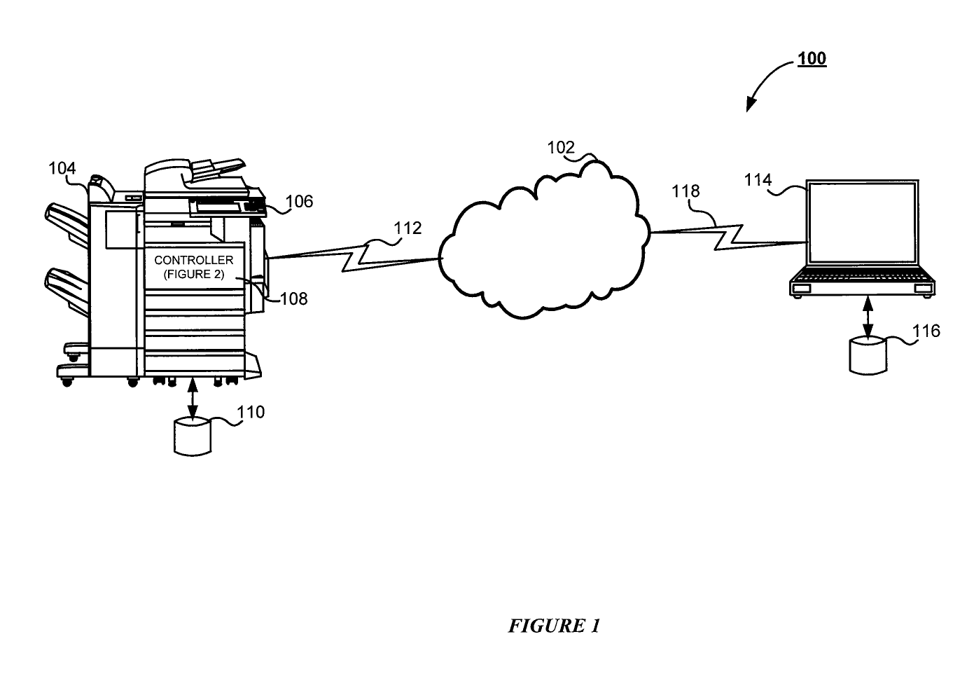

The subject application is directed to a system and method for processing of electronic documents for document output devices. In particular, the subject application is directed to a system and method for efficient processing of electronic documents in a staged or pipelined process. It will become apparent to those skilled in the art that the system and method described herein are suitably adapted to a plurality of varying electronic fields employing staged processing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for staged processing of electronic document processing jobs in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

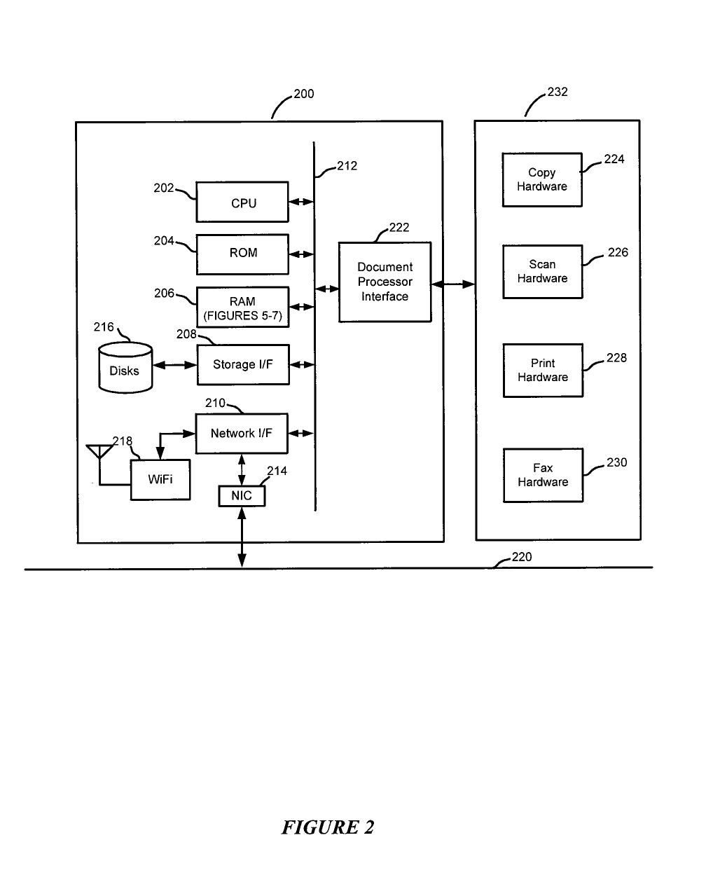

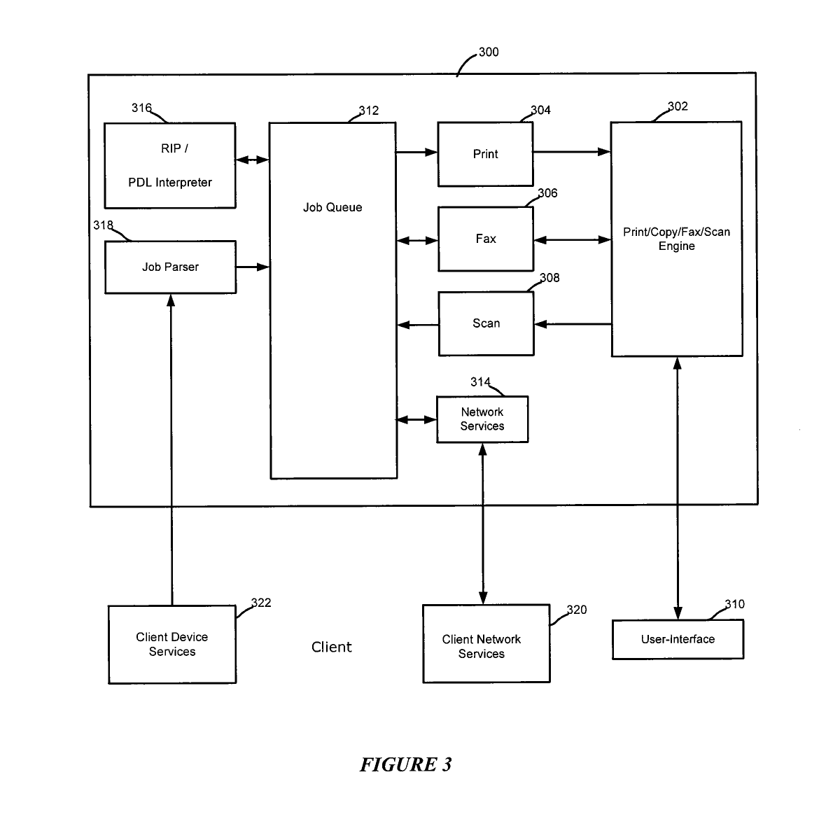

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for staged processing of electronic document processing jobs of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

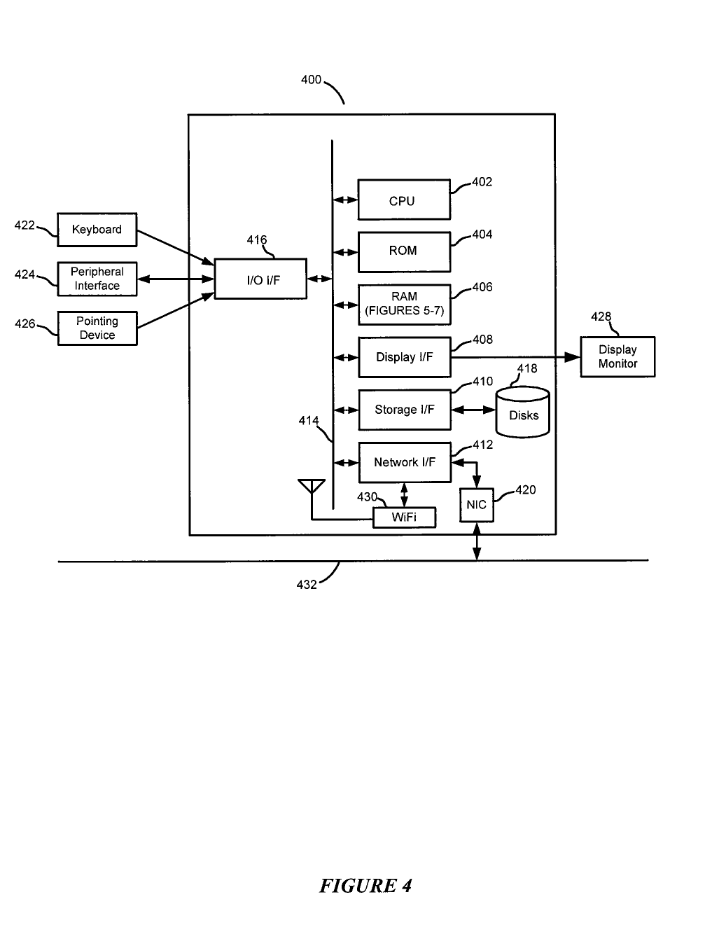

The system 100 illustrated in FIG. 1 further depicts a user device 114, in data communication with the computer network 102 via a communications link 118. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102. The functioning of the user device 114 will better be understood in conjunction with the block diagrams illustrated in FIG. 4, explained in greater detail below.

Communicatively coupled to the user device 114 is a data storage device 116. In accordance with the preferred embodiment of the subject application, the data storage device 116 is any mass storage device known in the art including, for example and without limitation, magnetic storage drives, a hard disk drive, optical storage devices, flash memory devices, or any suitable combination thereof. In the preferred embodiment, the data storage device 116 is suitably adapted to store a document data, image data, electronic database data, or the like. It will be appreciated by those skilled in the art that while illustrated in FIG. 1 as being a separate component of the system 100, the data storage device 116 is capable of being implemented as internal storage component of the user device 114, such as, for example and without limitation, an internal hard disk drive, or the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

Turning now to FIG. 4, illustrated is a hardware diagram of a suitable workstation 400, shown in FIG. 1 as the user device 114, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

In operation, a plurality of electronic documents, inclusive of setting data representing document processing device operations, are directed to at least one associated document processing device are received. Processing stages for each received electronic document are then identified in accordance with the corresponding setting data. Each received electronic document is then communicated to the correspondingly identified processing stages. A preselected document processing operation is then sequentially completed via each of the plurality of processing stages corresponding to each received electronic document.

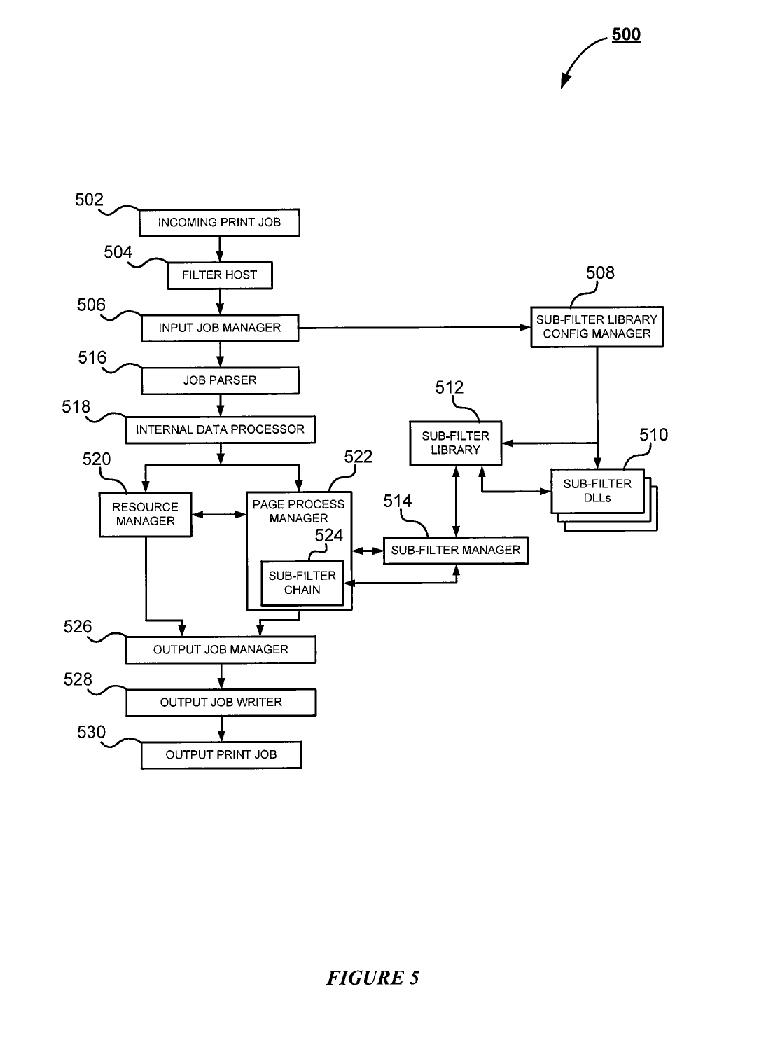

In accordance with one example embodiment, electronic documents inclusive of configuration, or setting data, is directed to a document processing device 104 and is received from a software driver associated with an application resident on the user device 124, the document processing device 104, or the like. According to one embodiment of the subject application, the setting data includes, for example and without limitation, page markup data, print ticket data (explained in greater detail below with respect to FIG. 5), or the like. The encoding type associated with each of the received electronic documents is then determined and processing stages, or filters, are identified for each document based upon the encoding type. The filters are then sequenced as groups of sub-filters, with each sub-filter group performing a document processing operation related to other document processing operations in the corresponding group. Document processing operations are then ordered for each document based upon the included setting data. Each document is then communicated to the identified filters. The filters thereafter perform preselected document processing operations according to a portion of the data associated with each corresponding electronic document. Thereafter, the preselected document processing operations are sequentially completed via each filter.

A further example embodiment is illustrated in FIG. 5, wherein there is shown a block diagram 500 depicting such an example embodiment of an implementation of the system 100 for staged processing of electronic document processing jobs in accordance with the subject application. The skilled artisan will appreciate that the various components depicted in FIG. 5 represent functions, hardware components, software components, or the like, used to implement the systems and methods of the subject application. As shown in FIG. 5, the components are illustrated as processing objects for example purposes only and the subject application is not limited solely to such an embodiment.

An incoming print job 502 is first received by a filter host 504. In accordance with one embodiment of the subject application, the incoming print job 502 corresponds to one or more electronic documents generated by, for example and without limitation, a software output driver resident on the user device 114 and communicated to the document processing device 104 via the computer network 102. Preferably, the incoming print job 502 includes setting or configuration data related to the output, preferences, options, and the like, associated with the output of the print job 502. Suitable examples of such setting data include, for example and without limitation, page markup data, print ticket data (explained below), or the like. The filter host 504 is suitably configured to manage the overall integration of the system 500 within the document processing device 104 environment and the setup and initialization of the other components, as will be understood by those skilled in the art. The incoming print job 502 is then received by an input job manager 506, which detects the type of the input job and invokes the appropriate job parser 516. In accordance with one embodiment of the subject application, the input job manager 506 is suitably adapted to examine the input job 502 and select an appropriate parser object, e.g., the job parser 516, for the determined encoding type, e.g., the job type. In addition, the input job manager 506 makes use of a sub-filter library configuration manager 508 to set up a sub-filter chain 524 for processing the job, e.g., the sub-filter library configuration manager 508 is called to access sub-filter dynamic link libraries (DLLs) 510, hereinafter referenced as sub-filters 510 and, in association with the sub-filter manager 514, construct the sub-filter chain 524 in accordance with received configuration data.

As used in this example embodiment, the sub-filters 510 correspond to a data object that is a single functional unit responsible for a single specific processing function on the input job 502. Thus, each sub-filter 510 performs a different function on the job 502. Each sub-filter 510 is self identifying so that the sub-filter library configuration manager 508 is able to use it appropriately according to configuration data. The collection of sub-filters 510 is managed by the sub-filter library 512 and the sub-filter library configuration manager 508. Furthermore, the skilled artisan will also appreciate that each sub-filter 510 is an instance of a page processor and holds a reference to another page processor that is used to process the output from the sub-filter 510.

The job parser 516, in accordance with this example, is an object used to parse the input job 502 into internal format and pass the parsed data on to an internal data processor 518. As will be understood by those skilled in the art, the specific instance of the job parser 516 is dependent upon the input job type as detected by the input job manager 506, e.g., for an eXtensible Markup Language Page Specification (XPS) job will invoke an XPS job parser to parse the incoming print job 502. In accordance with this example embodiment, the sub-filter library configuration manager 508 is advantageously used to set up a sub-filter chain 524 for processing the print job 502. In accordance with one embodiment of the subject application, the sub-filter library configuration manager 508 sets up the sub-filter library 512 as a collection of sub-filters 510 to be used and facilitates the ordering of access to the sub-filters 510. Preferably, the sub-filter library 512 functions to register and de-register sub-filters 510 within the system 500 and provides access to the sub-filters 510 to other components of the system 500.

It will be appreciated by those skilled in the art that the construction of the sub-filter chain 524 suitably includes accessing and registering, by the manager 508, all available sub-filters 510, linking, according to received configuration data, the sub-filters 510 into the sub-filter chain 524 by setting the output page processor of each sub-filter 510 to be the next sub-filter 510 in the sub-filter chain 524, instruct an output job manager 526 to instantiate an appropriate output job writer 528 according to configuration data, and set the output job writer 528 as the output page processor for the last sub-filter 510 in the sub-filter chain 524. In accordance with one embodiment of the subject application, the sub-filter chain 524 is representative of a sequence of sub-filters 510 and set up by the sub-filter library configuration manager 508. As indicated above, each sub-filter 510 is an instance of a page processor. The first sub-filter 510 in the chain 524 is called via a page processor interface associated with the page process manager 522. Each sub-filter 510 in the chain 524 calls on to the next sub-filter 510 in the chain 524 as represented by its output page processor using the page processor interface.

Following invocation of the job parser 516, an internal data processor 518 is initiated for the overall coordination of the processing of the print job 502. The internal data processor 518 maintains an instance of a resource manager 520 and of a page process manager 522, receives calls from the job parser 516, passes on these calls to the page process manager 522 for distribution to the sub-filter chain 524, accepts calls from sub-filters 510 for access to resources which are passed on to the resource manager 520, and maintains information about the overall document sequence in the job 502, the current document, and the current document page. As will be understood by those skilled in the art, the resource manager 520 is representative of an object that manages all access to resources used for processing the job 502. Furthermore, it will be appreciated by the skilled artisan that the resource manager 520 is capable of making requests to the job parser 516 to access resource data associated with the job 502.

The output job manager 526, referenced above, is preferably used to select an output job writer 528 to produce the final output 530 from the system 500. The skilled artisan will appreciate that the specific output job writer 528 selected by the output job manager 526 is dependent upon configuration data supplied in associated with the received print job 502. The output job writer 528 suitably corresponds to a component of the system 500 that is used to facilitate the conversion of the internal format job data into suitable output format data. Thus, for example and without limitation, when the selected output job writer 528 is an XPS output job writer, the final output data is in the form of an XPS job. The skilled artisan will appreciate that the output job writer 528 is an instance of a page processor and that the appropriate output job writer 528 is set as the output page processor for the last sub-filter 510 in the sub-filter chain 524. It will also be understood by those skilled in the art that each sub-filter 510, as well as the output job writer 528, are representative of page processors, e.g., each provides a standard interface for processing all aspects of a given job 502.

Further, in accordance with the foregoing example implement depicted in FIG. 5, the skilled artisan will appreciate that additional data objects are used to represent and convey job related data. Such additional data objects include, for example and without limitation, a document sequence data object that is representative of job as a sequence of contained documents. Accordingly, the object includes information corresponding to the number of such documents in a job 502 and the document level processing options in a document print ticket. A page object is representative of information about a single page of a document within a job 502. Such an object includes information about the page number within the document and the page level processing options in a page print ticket. A node object represents a single page markup element within a page. The node object is the primary object upon which the sub-filters perform the processing operations within the context of the page, document, and job. The print ticket object represents various options that apply to the object to which it is attached.

Once the setup of the sub-filter chain 524 has been completed, as set forth above, the incoming print job 502 is ready for processing. That is, processing, under the direction of the job parser 516, is commenced. In accordance with this example embodiment of the subject application, the job parser 516 initiates calls to the internal data processor 518 for each of the following events: start of document sequence (i.e., start of the job 502), end of document sequence (i.e., end of the job 502), start of document, end of document, start of page, end of page, start of node, end of node. It will be understood by those skilled in the art that the start and end of node events are matched in nest pairs so as to represent the markup structure of the page data.

The internal data processor 518 then passes these calls on to the page process manager 522 following the assembly of any additional related data, as will be appreciated by those skilled in the art. The page process manager 522 then calls on the sub-filter chain 524 via the page processor interface of the first sub-filter 510 in the sub-filter chain 524. After any appropriate processing by the first sub-filter, the calls are passed through the sub-filter chain 524 by each sub-filter 510 to the next sub-filter 510 via the associated page processor interfaces to the output page processors for the corresponding sub-filters 510. The job output writer 528 is then called as the final page processor in the sub-filter chain 524.

The skilled artisan will appreciate that as a result of each event that occurs in the job parser 516 is notified on to the internal data processor 518 and so on down the processing chain 524 as soon as it is detected, the job output writer 528 is capable of producing the output job 530 before the job parser 516 has completed parsing the whole job 502. In addition to processing and/or modifying the job data passed to it, each sub-filter 510 is also capable of making changes to the data. Suitable examples of such changes include, for example and without limitation, injection of additional node elements, e.g., add watermarks, crop marks, scale pages, or the like, inject additional pages, e.g., add cover pages, separator pages, or the like, remove redundant elements or otherwise modify the order of elements, re-order pages, e.g., reverse printing output, or combine pages into a single page, e.g., N-up or booklet production.

In accordance with the foregoing explanations of the example embodiment illustrated in FIG. 5, the skilled artisan will appreciate that the sub-filters 510 are capable of retaining copies of data objects for later output, omit the calling of the next sub-filter, make additional calls on the next sub-filter, all as required to perform its operation. Those skilled in the art will therefore appreciate that the sequence of calls that a sub-filter 510 makes on the next sub-filter 510 in the chain 524 follows the following format:

```
Start Document Sequence
(Repeat for each document:
    Start Document
    (Repeat for each page in document:
        Start Page
        (Repeat for each markup element in page in nested pairs:
            Start Node
            End Node
        End Page
    End Document
End Document Sequence
```

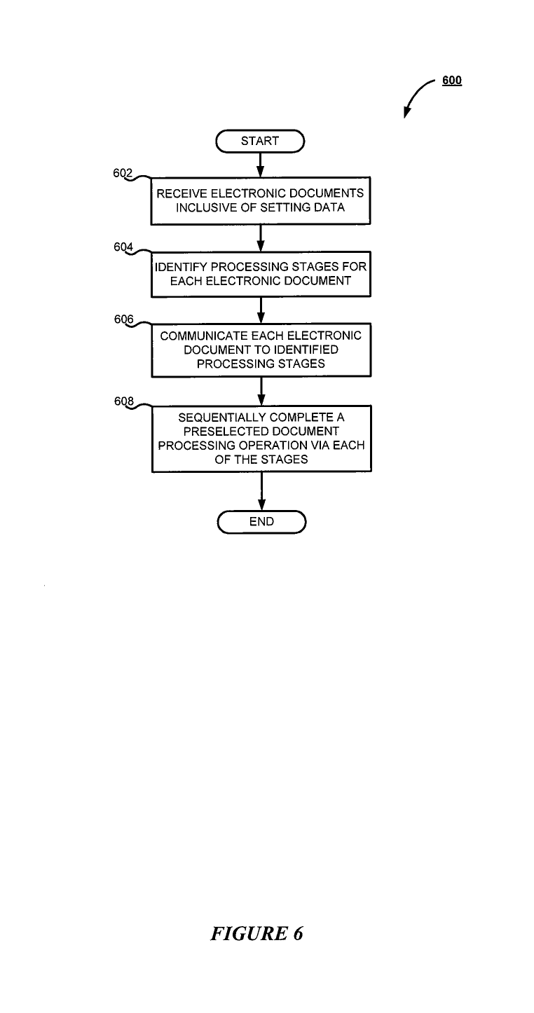

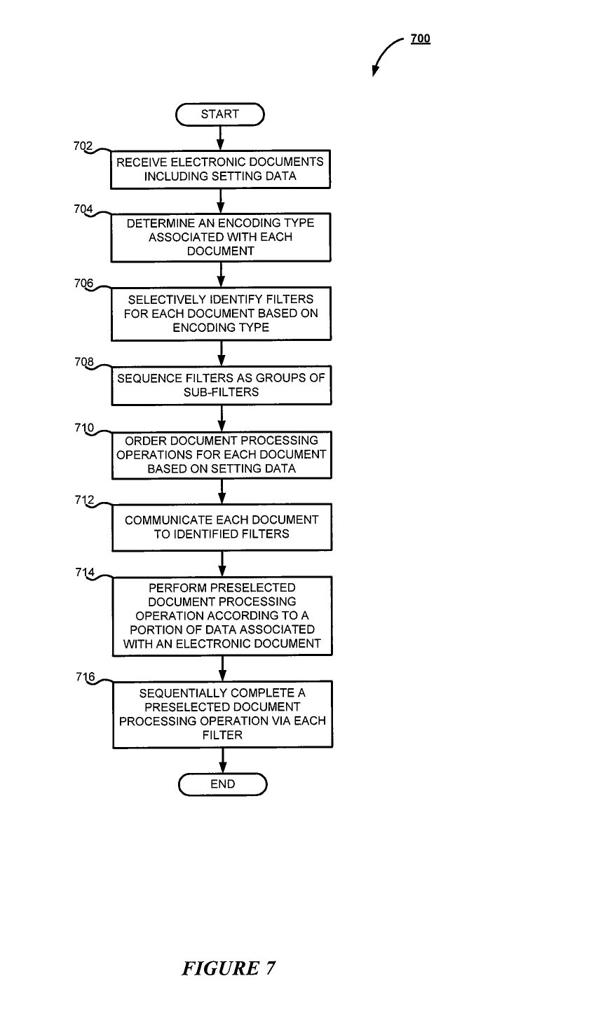

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for staged processing of electronic document processing jobs in accordance with one embodiment of the subject application. Beginning at step 602, a plurality of electronic documents directed to at least one associated document processing device 104 and having setting data corresponding to document processing operations to be performed on the electronic documents, are received. In accordance with one embodiment of the subject application, the setting data corresponds to, for example and without limitation, page markup data, print ticket data, or the like. Processing stages, such as filters 510, are then identified at step 604 in accordance with the setting data.

At step 606, each electronic document, based upon the identification performed in step 604, is then communicated to the identified processing stages. Each of the identified processing stages then sequentially performs a document processing operation corresponding to each received electronic document at step 608.

Referring now to FIG. 7, there is shown a flowchart 700 illustrating a method for staged processing of electronic document processing jobs in accordance with one embodiment of the subject application. The method depicted in FIG. 7 begins at step 702, whereupon electronic documents, such as the print job 502, directed to the document processing device 104 are received with associated setting, or configuration data. In accordance with one embodiment of the subject application, the print job 502 is generated by a suitable software driver or the like resident on the user device 114 and communicated to the document processing device 104 via the computer network 102. According to another embodiment of the subject application, the filter system 500 is a suitable component of the driver resident on the user device 114, e.g., a component of a WINDOWS-based printer driver, which receives the job data from the WINDOWS environment and performs the processing described hereinafter. The skilled artisan will further appreciate that the system 500 is further capable of implementation in a UNIX-based system, e.g., a UNIX print filter. It will be apparent to those skilled in the art that the subject application is capable of implementation on the user device 114, the document processing device 104, or any other suitable electronic device used for outputting documents. According to one embodiment of the subject application, the setting, or configuration data, includes, for example and without limitation, page markup data, print ticket data, or the like.

At step 704, a determination is made as to the encoding type associated with each electronic document received in the print job 502. That is, the filter host 504 begins the initialization and overall setup of the other components of the filter system 500, e.g., the input job manager 506, the job parser 516, and the like. Thus, at step 704, the input job manager 504 determines the job type associated with the incoming print job 502. In accordance with one embodiment of the subject application, the encoding type corresponds to the page description language associated with the print job 502 including, for example and without limitation, POSTSCRIPT, XPS, or any other suitable format as are known in the art. As such, the input job manager 506 identifies the correct job parser 516 based upon the encoding type and thereafter initializes the job parser 516.

Filters are then identified, for example by the input job manager 506 via the sub-filter library configuration manager 508, corresponding to each received electronic document in accordance with each document encoding type at step 706. Stated another way, the manager 508 facilitates the identification of those sub-filters 510 associated with the encoding type of a given document so as to generate the sub-filter library 512. The filters are then sequenced at step 708 as groups of sub-filters 510, e.g., into a sub-filter chain 524 via the sub-filter manager 514. The skilled artisan will appreciate that each sub-filter group performs a document processing operation related to other document processing operations in a corresponding group. At step 710, the document processing operations for each document are then ordered based upon the received setting data. For example, the internal data processor 518, using the page process manager 522, sets the processing order of the document processing operations based upon output from the job parser 516.

At step 712, each document is communicated to the corresponding identified filters. For example, the page processor 522 communicates calls received via the internal data processor 518 from the job parser 516 to the sub-filters 510 of the sub-filter chain 524 for further processing. At step 714, a preselected document processing operation is performed according to a portion of data associated with an electronic document. That is, a sub-filter 510 in the sub-filter chain 524 performs a document processing operation on data received from the job parser 516 via the internal data processor 518 and the page process manager 522. A preselected document processing operation is then sequentially completed at step 716 via each filter. As stated in greater detail above, the sub-filters 510 in the sub-filter chain 524 sequentially perform their corresponding document processing operations on the data received from the job parser 516 resulting in output to the output job manager 526. Thereafter, the output job manager 526 communicates the processed data to the output job writer 528 and outputs the print job at 530.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for staged processing of electronic document processing jobs comprising:
means adapted for receiving a plurality of electronic documents directed to at least one associated document processing device, each received electronic document having setting data representative of document processing device operations corresponding thereto;
identification means adapted for identifying a plurality of processing stages for each received electronic document in accordance with the setting data that corresponds thereto;
means adapted for communicating each received electronic document to a plurality of processing stages in accordance with an output of the identification means; and
means adapted for sequentially completing a preselected document processing operation via each of the plurality of processing stages corresponding to each received electronic document.

2. The system of claim 1 further comprising sequencing means adapted for ordering document processing operations for each electronic document in accordance with setting data corresponding thereto.

3. The system of claim 2 wherein each processing stage is comprised of a filter, which filter includes means adapted for performing its corresponding preselected document processing operation in accordance with a portion of data associated with an electronic document.

4. The system of claim 3 further comprising means adapted for sequencing a plurality of the filters as groups of sub-filters, each sub-filter group performing a document processing operation related to other document processing operations in a corresponding group.

5. The system of claim 2 wherein the setting data includes at least one of page markup data and print ticket data.

6. The system of claim 1 further comprising:
means adapted for determining an encoding type associated with each electronic document; and
means adapted for selecting an identification means in accordance with a determined encoding type.

7. A method for staged processing of electronic document processing jobs comprising the steps of:
receiving a plurality of electronic documents directed to at least one associated document processing device, each received electronic document having setting data representative of document processing device operations corresponding thereto;
identifying a plurality of processing stages for each received electronic document in accordance with the setting data that corresponds thereto;
communicating each received electronic document to a plurality of processing stages in accordance with an output of the identification step; and
sequentially completing a preselected document processing operation via each of the plurality of processing stages corresponding to each received electronic document.

8. The method of claim 7 further comprising the step of ordering document processing operations for each electronic document in accordance with setting data corresponding thereto.

9. The method of claim 8 wherein each processing stage is comprised of a filter, wherein the method further includes performing a corresponding preselected document processing operation in accordance with a portion of data associated with an electronic document.

10. The method of claim 9 further comprising the step of sequencing a plurality of the filters as groups of sub-filters, each sub-filter group performing a document processing operation related to other document processing operations in a corresponding group.

11. The method of claim 8 wherein the setting data includes at least one of page markup data and print ticket data.

12. The method of claim 7 further comprising the steps of:
determining an encoding type associated with each electronic document; and
selectively identifying a plurality of processing stages for each received electronic document in accordance with a determined encoding type.

13. A computer-implemented method for staged processing of electronic document processing jobs comprising the steps of:
receiving a plurality of electronic documents directed to at least one associated document processing device, each received electronic document having setting data representative of document processing device operations corresponding thereto;
identifying a plurality of processing stages for each received electronic document in accordance with the setting data that corresponds thereto;
communicating each received electronic document to a plurality of processing stages in accordance with an output of the identification step; and
sequentially completing a preselected document processing operation via each of the plurality of processing stages corresponding to each received electronic document.

14. The computer-implemented method of claim 13 further comprising the step of ordering document processing operations for each electronic document in accordance with setting data corresponding thereto.

15. The computer-implemented method of claim 14 wherein each processing stage is comprised of a filter, wherein the method further includes performing a corresponding preselected document processing operation in accordance with a portion of data associated with an electronic document.

16. The computer-implemented method of claim 15 further comprising the step of sequencing a plurality of the filters as groups of sub-filters, each sub-filter group performing a document processing operation related to other document processing operations in a corresponding group.

17. The computer-implemented method of claim 14 wherein the setting data includes at least one of page markup data and print ticket data.

18. The computer-implemented method of claim 13 further comprising the steps of:
determining an encoding type associated with each electronic document; and
selectively identifying a plurality of processing stages for each received electronic document in accordance with a determined encoding type.
